(19) United States
(12) Patent Application Publication
(10) Pub. No.: US 2009/0053366 A1
(43) Pub. Date: Feb. 26, 2009

(54) Refreshment system having effervescent supplement tablets

(76) Inventors: Marni Markell Hurwitz, Far Hills, NJ (US); Ernest D. Buff, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/079,378

(22) Filed: Mar. 26, 2008

Related U.S. Application Data
(63) Continuation-in-part of application No. 11/894,456, filed on Aug. 21, 2007.

(51) Int. Cl. A23L 2/40; A23L 1/30; A23L 1/302; A23L 1/303; A23L 2/38; B65D 85/72; B65D 81/32

(52) U.S. Cl. 426/73; 426/591; 426/72; 426/89; 426/125; 426/115

(57) ABSTRACT

An effervescent supplement tablet is especially adapted for use in a beverage. The tablet contains a supplement ingredient and effervescent ingredients, including citric acid and sodium bicarbonate. The effervescent supplement tablet may additionally contain nutritional ingredients, such as vitamins or/and minerals, flavoring, sugars, sweeteners and/or medicaments, minerals or an electrolyte. Such effervescent supplement tablets are housed in one or more peel away packages that are adhesively attached to an external surface of a water-containing vessel, so that the effervescent supplement tablets are part of a fluid refreshment system. The packages are made from sealed polyethylene film having a continuous aluminum coating, which is moisture resistant and enables the packages to withstand washing of the vessel. Each of the packages has a notch therein to facilitate tearing. One or more packages are torn open, and the effervescent supplement tablet is emptied into the bottled water to create a custom beverage. Refill packages containing peel away effervescent supplement tablet packages can be marketed separately from the fluid refreshment system/kit, thereby enabling the effervescent supplement tablets to be purchased separately.

### CROSS-REFERENCE TO RELATED APPLICATIONS

This application is a continuation-in-part of U.S. patent application Ser. No. 11/894,456, filed Aug. 21, 2007, the disclosure of which is hereby incorporated in its entirety by specific reference thereto.

### BACKGROUND OF THE INVENTION

1. Field of the Invention

The present invention relates to effervescent supplement tablets appointed to be dissolve in fluid refreshment contained within a vessel; and, more particularly, to a tablet containing supplement ingredients therein, such as flavors, scents, vitamins, minerals, hydration enhancers, nutrients, or medically effective compositions, and having effervescent properties that facilitate dissolution of the tablet in water prior to consumption.

2. Description of the Prior Art

Many patents address issues related to providing nutritional supplements in a powder form, pill form or mixture appointed for addition to a beverage. It has been recognized that adding nutritional supplements such as vitamin C or iron supplements into a drink results in discoloration of the drink. Furthermore, such addition of nutritional supplements deteriorates taste properties of the drink and reduces its nutrient efficacy during storage prior to consumption.

U.S. Pat. Nos. 5,032,411, 5,114,723 to Stray-Gundersen disclose beverage compositions for human consumption. Aqueous hypotonic beverage compositions appointed for oral administration contain physiologically essential electrolytes, nutrient minerals, carbohydrates, and other ingredients advantageous to a human body. The hypotonic beverage composition comprises an aqueous solution, either carbonated or non-carbonated, electrolytes, carbohydrates, low-caloric sweetener, and edible acid components. The concentrate is a dry powder appointed to be mixed with water to form the aqueous beverage and is not an effervescent tablet. Further, the concentrate additive is not contained in a peel away package attached to a water bottle.

U.S. Pat. No. 5,609,897 to Chandler, et al. discloses a powdered beverage concentrate or additive fortified with calcium and vitamin D. This powdered beverage concentrate contains calcium glycerophosphate, vitamin D, vegetable oil, a gum, vitamin C, an acidulant, a sweetener, a glucose polymer and a flavoring agent. The powdered beverage concentrate contains from 7.2 to 18.0% by wt. of calcium source. A beverage can be made by reconstituting the beverage concentrate with water, fruit juice, or any other suitable liquid matrix. The beverage concentrate contains vegetable oil in liquid form; and is not a free flowing powder. The beverage concentrate is not present in a compressed powder tablet form having effervescent properties for enhanced dissolution in water.

U.S. Pat. No. 5,681,606 to Hutchison, et al. discloses a method of preparing a water-based beverage. A beverage is prepared in the form of a dilute aqueous solution, suspension or dispersion of an encapsulated product. The capsule is added to a potable liquid. Capsule material breaks down when submerged in the liquid, causing the capsule to release its contents and dissolve. When provided in this manner, the product can be confined within the capsule in liquid from, and can therefore disperse or dissolve in water more readily. Additionally, the capsule tends to sink to the bottom of the body of water before releasing its contents, thereby ensuring that the contents are released within the body of water, and not at the water surface. The added capsules include an aqueous solution encapsulated in the capsule's outer material. It is not in compressed powder tablet form having effervescent properties for enhanced dissolution in water.

U.S. Pat. No. 6,287,596 to Murakami, et al. discloses quickly disintegratable compression-molded materials and a process for producing the same. This quickly disintegratable compression-molded material contains erythritol, a tetrahydric sugar alcohol produced by the fermentation of glucose, and fillers such as starches, celluloses, and sugar alcohols and vitamins. The vitamins include vitamin A, vitamin D, vitamin E (such as d-.alpha.-tocopherol acetate), vitamin B₁ (such as thiamin hydrochloride), vitamin B₂ (such as riboflavin), vitamin B₆ (such as pyridoxine hydrochloride), vitamin C (such as ascorbic acid and sodium ascorbate), vitamin B₁₂ (such as hydroxocobalamin acetate), nicotinamide, calcium pantothenate, and pantethine. The quickly disintegratable compression-molded material exhibits rapid disintegration and dissolution when placed in the oral cavity or water. It has high strength and does not collapse during the manufacturing process. The quickly disintegratable compression-molded material is not a compressed powder tablet form having effervescent properties for facilitating dissolution when placed in water.

U.S. Pat. No. 6,472,007 to Bezek, et al. discloses a consumables container with a multi-functional cap. This container houses food and other perishable products. It comprises a multi-functional cap that allows for the storage of multiple products separately within the container and consumption of the products while “on the go.” The multi-functional cap nests over and seals the mouth end of the container. This allows for the nesting of a sub-container inside the cap, and permits the products to be resealed without contaminating each other. The container is ergonomically and stylishly shaped with a comfortable handgrip. Each of the products is contained within the multifunctional cap, and the product is not in a compressed powder tablet form appointed with supplement ingredients and having effervescent properties for facilitating dissolution when placed in water.

U.S. Pat. Nos. 6,681,958, 6,681,958 to Sorenson, et al. disclose a supplement compartment for a beverage container. A supplement compartment in the lid of a liquid container contains individually accessible compartments for vitamin, mineral, analgesic, antibiotic or other medicine, flavor or other color additive or nutritional additive. The supplement may be a solid, or a semi-solid, or a liquid or a gas. The solid may comprise a pill, tablet, granule, powder or the like. The semi-solid may comprise a paste, cream, gel, or the like. The liquid may comprise a hydrous or nonhydrous solution. The supplement is not contained in a tablet form having effervescent properties for facilitating disbursement of ingredients during dissolution in water.

U.S. Pat. No. 7,014,876 to Iwasaki, et al. discloses a packaged beverage. This packaged beverage comprises ingredients (A) and (B). Ingredient (A) is a non-polymer catechins (green tea extract) in an amount of from 0.092 to 0.5 g/100 mL of beverage. Ingredient (B) is an alcoholic precipitate in an amount of 0.015 g/100 mL of beverage or less in terms of the amount of magnesium, at a weight ratio (A)/(B) ranging from 30/1 to 50000/1. The packaged beverage is said to be best suited for health promotion. Drinking of it permits transfer of a large amount of catechins to the blood form the beverage, and the absorption within the body is excellent. The A and B constituents are dissolved in the water and are not provided in a tablet form having effervescent properties for facilitating disbursement of constituents during dissolution in water.

U.S. Pat. No. 7,090,878 to Mehansho, et al. discloses mineral fortified water. This water composition is fortified with at least one mineral and has a pH between about 2.5 and 9.5 with a redox potential that satisfies the equation 0≧RP-(A-B*pH) wherein RP is the redox potential in millivolts of the mineral-containing water composition, pH is the pH of the mineral-containing water composition, A is 400 and B is 20. The mineral is selected from calcium, iron, zinc, copper, manganese, iodine, magnesium, and their mixtures. The mineral-fortified water composition is free of flavor or sweetener compounds with no metallic taste or after-taste, a Hunter colorimetric “b” reading of less than 5.0, and an NTU turbidity value of less than 5.0. The mineral-fortified water composition may also contain other nutrients and vitamins, for example, vitamin A, vitamin C, vitamin E, niacin, thiamin, vitamin B₆, vitamin B₂, vitamin B₁₂, folic acid, selenium, and pantathonic acid. Both the minerals and vitamins are added to the water composition and are not in a tablet form having effervescent properties for facilitating disbursement of nutrients during dissolution in water.

U.S. Pat. No. 7,115,297 to Stillman discloses nutritionally fortified liquid composition with added value delivery systems/elements/additives. This bottled water-like composition includes a fiber-water as the base for new compositions. It creatively uses encapsulations and viscosity modifications as delivery vehicles, thereby designing products that target obesity, diabetes, heart health, improved general health and well being, stress, depression, pain, fostering a healthy digestive tract, and the binding and removing of toxins from the body, thus intending to reduce the incidences of cancer, etc. Immune enhancing, anti-bacterial and anti-viral, compositions are manipulated via viscosity changes and encapsulations. These additive compositions are not contained in a tablet form having effervescent properties for facilitating distribution of additive ingredients during dissolution in water prior to consumption. Rather they are mixed into fiber-enriched water that is thereafter sold for consumption.

There remains a need in the art for an effervescent supplement tablet appointed to be dissolved in fluid refreshment contained within a vessel wherein supplement ingredients, including, flavors, scents, vitamins, minerals, hydration enhancers, nutrients, or medicaments may be selected and added to a water-containing vessel by the consumer prior to consumption to thereby substantially uniformly distributed nutritional ingredients or medically effective agents according to the needs of the consumer.

### SUMMARY OF THE INVENTION

The present invention is directed to an effervescent supplement tablet appointed to be dissolved in a glass, bottle, disposable water bottle (as sold), pet dish or the like. The supplement tablet includes effervescent properties so that it readily dissolves and facilitates substantially uniform distribution of the ingredients in an economical, efficient manner. The tablet includes supplement ingredients, such as flavor enhancers, scents, and may include nutritional ingredients, such as vitamins, minerals, hydration enhancers, nutrients, or medicaments. Delivery of the supplement ingredients is effectuated by simply adding the tablet to the water, allowing it to dissolve, and consuming the water beverage. In one embodiment, the effervescent tablet is especially suited for addition to a water drink. The tablet is sold separate from the drink, packaged in a container or packaged in individual packaging or wrappers, with different flavorings and/or different supplement and/or nutrient properties. In another embodiment, the tablets are provided as an effervescent supplement tablet system and are integrally associated with a water-containing vessel, so that the tablet is simply removed from the exterior of the vessel and added to the vessel interior by the consumer prior to consumption to thereby provide or augment nutritional ingredients or medically effective agents according to the needs of the consumer. According to this embodiment, the liquid-containing vessel, such as a bottle, carton or the like, includes an outer-side wall to which are attached one are more peel away packages containing effervescent supplement tablets. The user peels off one or more of the attached packages and adds the effervescent supplement tablet, which dissolves in a highly efficient manner. An effervescent agent facilitates substantially uniform distribution and rapid release of ingredients contained within the tablet. Mixing of ingredients is accelerated, enabling consumption of fluid contained within the vessel soon after addition of the tablet.

Addition of an effervescent supplement tablet containing the above-described ingredients to liquid, such as water, affords several advantages over systems wherein the water and ingredients are pre-mixed and then sold for consumption. A consumer does not have to purchase a plurality of water bottles, each containing a different flavor, taste enhancing ingredient, vitamin, or the like. Instead, the consumer selects the effervescent supplement tablet of choice and adds the ingredients to the bottled water before consuming the mixture. If two of the constituents interact chemically, due to the short time of dissolution extant, their functionality is maintained. An example of this type of mixture is the addition of citric acid with bicarbonate to create carbon dioxide bubbles. Vitamins that deteriorate over time due to exposure to oxygen or light are preserved. The vitamins remain in powder form compressed within the tablet, which is sealed to prevent their degradation by moisture and light.

A first embodiment provides an effervescent supplement tablet for use in a beverage that is composed of a supplement ingredient and effervescent ingredients. Effervescent ingredients cause the supplement effervescent tablet to effervescently dissolve, i.e. give off gas bubbles when dissolving, in the beverage to efficiently distribute and deliver the supplemental ingredient to a person or animal during consumption of the beverage. The effervescent supplement tablet is appointed to be dissolved in the beverage, thereby customizing the beverage to a desired taste or supplement need. The effervescent supplement tablet may further comprise a nutritional ingredient, such as vitamins and/or minerals. The effervescent supplement tablets may be housed in a peel away package that is adhesively attached to an external surface of a water-containing vessel so that the effervescent supplement tablets form part of a fluid refreshment system.

A second embodiment provides a fluid refreshment system including a liquid containing vessel having a closure cap and an external surface appointed with one or more peel away packages adhesively attached thereto. These peel away packages contain effervescent supplement tablets therein. The effervescent supplement tablets comprise: (i) a supplement ingredient; and (ii) effervescent ingredients. As composed, the effervescent supplement tablets fizz and dissolve in the fluid refreshment to deliver the supplemental ingredient to a person or animal during consumption. The fluid refreshment system further enables one or more packages to be adapted to be peeled away and torn open to deliver the effervescent supplement tablet into fluid refreshment within the vessel. Advantageously, the user may select one or more effervescent supplement tablets for addition to the fluid refreshment, thereby customizing the fluid refreshment without having to buy, transport and store multiple, commercially sold vessels containing premixed liquid compositions. The vessel with peel away effervescent supplement tablets is preferably a throwaway water bottle with one or more peel away packages thereon. The user may choose one or more effervescent supplement tablets and discard the bottle with unused peel away packages. In another preferred embodiment, the vessel with peel away effervescent supplement tablet packages is a refillable water bottle with one or more peel away packages, such as used by a single user, or as gallon water bottles as used at a water cooler. The user may wash the bottle and refill it with fresh water. The user may also purchase one or more peel away effervescent supplement tablet packages and attach them to the external sidewall surface side of the water bottle/water cooler gallon bottle after peeling off a protective tape cover to expose the adhesive. The fluid refreshment system may provide a plurality of bottles, which may be sold as a “six pack”, or “kit”. Still further, refill packages containing peel away effervescent supplement tablet packages can be marketed separately from the fluid refreshment system/kit so that the effervescent supplement tablets can be purchased separately.

### BRIEF DESCRIPTION OF DRAWINGS

The invention will be more fully understood and further advantages will become apparent when reference is had to the following detailed description and the accompanying drawings, in which:

FIG. 1 is a schematic view of a glass containing water to which an effervescent supplement tablet has been added and is dissolving, giving off gas bubbles;

FIG. 2 is a schematic view of the water bottle with peel away packages containing effervescent supplement tablets, wherein a package has been peeled away and an effervescent supplement tablet has been added to water within the water bottle;

FIG. 3 is a schematic view of the peel away packages, each containing an effervescent supplement tablet, wherein the peel away packages are designed for attachment to a refillable water bottle, or disposable water bottle; and

FIG. 4 is a schematic view of the water cooler—gallon bottle with peel away packages containing effervescent supplement tablets therein, wherein the peel away packages are designed for attachment to a gallon jug located on a water cooler device so that an effervescent supplement tablet can be readily added to a glass of water dispensed form the water cooler.

### DESCRIPTION OF THE PREFERRED EMBODIMENTS

Water bottles have been widely accepted by consumers due to their health benefits. Water has zero calories and hydrates the user. Throwaway water bottles are generally purchased by consumers in bulk quantities occupying large trunk space and storage space. Several companies sell washable water bottles made from polycarbonate or high-density polyethylene polymers.

More recently, the trend has been to market water bottles with sweeteners, juice drinks, taste and flavor enhancers and vitamin and/ or mineral supplements. Prolonged storage of vitamins and/ or mineral supplement containing bottled water results in reduction in potency of vitamins and/ or minerals as well taste and flavor deterioration. Preservation of taste and flavor requires addition of chemicals to the packaging or the bottled water, which may not be of nutrition value and in fact may harm the user in the long run.

It is therefore advantageous if the supplement has the form of effervescent supplement tablets contained in peel-away packages, and is added to bottled water immediately prior to consumption 765. This assures that vitamin and/or mineral nutrients have full potency; that medically effective supplements are free from chemical reaction products; and that flavor and taste enhancing supplements provide expected flavor and taste. In addition, the user may select more than one peel away effervescent supplement tablet package to create a custom bottled water beverage according to taste preferences.

The key requirement for the proper functioning of the effervescent supplement tablets is that the ingredients contained therein are formed via compressing finely powdered ingredients, including at least one supplement ingredient (which may include a flavoring and/sugar) and effervescent ingredients so that the tablet undergoes chemical reaction when dissolving in water, giving off gas to yield an effervescent solution. In the case of compressible powders, the dissolution rate of powder material is function of its composition and its particle size. While the composition is pre-selected, it is generally not a variable, but the particle size of the powder can be controlled by the manufacturing process of the effervescent supplement tablet. Where necessary, binders may be added, which may simply be provided as pectin type gels, or gelatinous material that is mixed with the powder and compressed with same to form the tablet. Consider a volume of V centimeter cube of a powder with an average particle size of d microns. N is the number of particles needed to fill the space of V cubic centimeters. The following equation shows the relationship between V, d and N.

$$V = N ( \frac{4}{3} π \frac{{d}^{3}}{8} )$$

The surface area S of the N particles of diameter d is given by the equation:

$$S = N π {d}^{3} = \frac{6 V}{π d}$$

Therefore decreasing the particle size from 100 mesh (140 microns diameter) to 325 mesh (44 micron diameter) results in a surface area increase of 140/44 or 3.18. If the particle size were reduced to 5 microns, the surface area will increase by 140/5 or 28 times.

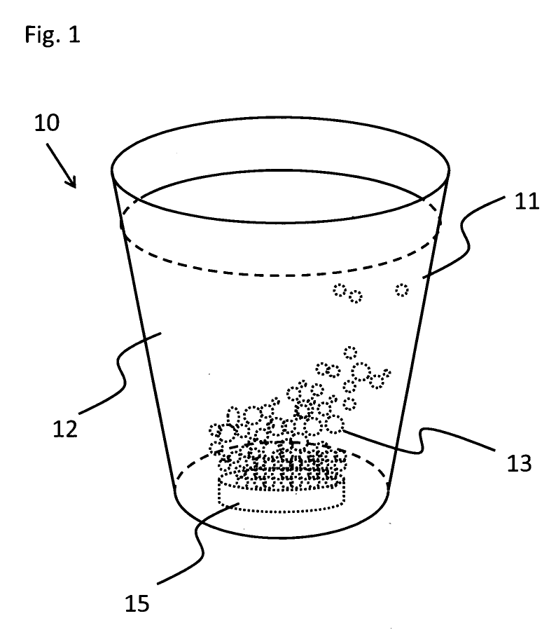

FIG. 1 is a schematic view of a glass with water therein in which an effervescent supplement tablet has been added and is dissolving, giving off gas bubbles, shown generally at 10. An effervescent supplement tablet 15 is dropped in a vessel, herein a glass, 11 of water 12 for consumption. The effervescent supplement tablet 15 is composed of a supplement ingredient and effervescent ingredients so that the supplement effervescent tablet 15 effervescently dissolves, giving off gas bubbles 13, in the beverage/water 12 to deliver the supplemental ingredient to a person or animal during consumption. The effervescent supplement table 15 effectively dissolves in water 12 to provide customized flavoring and/or supplement and nutritional ingredients delivery. The effervescent supplement tablet 15 may further comprise a nutritional ingredient, including a vitamin composition and/or a mineral composition. Alternatively, the nutritional ingredient may be an electrolyte composition. Preferably, the vitamin composition includes vitamin A, vitamin B1, B2, B6, B12, vitamin C, vitamin E and coenzyme (CQ10). Typical vitamins in powder form includes vitamin C, B1, B2, B6, B12, folic acid coenzyme (CQ10) and D. Typical liquid or semi-solid vitamins include vitamin A and E. Mineral compositions may include calcium compounds, preferably calcium citrate, magnesium compound, preferably magnesium citrate, chromium compound, preferably chromium picolinate or Niacin chromium GTF complex, zinc compound, selenium compound, iron compounds and others. Anti-oxidants include coenzymes. Hydrating substances include sodium and potassium chloride.

Composition of the supplement ingredients may include at least one of a flavor enhancing ingredient and a taste enhancing ingredient. Flavor enhancing ingredients preferably include orange flavor, lemon or lime flavor, guava flavor, mango flavor, dragon fruit flavor, green tea, caffeine and guarana, peach flavor, or strawberry flavor. Alternatively, the effervescent supplement tablet includes the taste enhancing ingredients of sweetener, sugars, pectin, fruit juice (in powder concentrate form) and an acidifier. Additionally, the supplement ingredient may comprise at least on medically effective agent, including aspirin, and other over the counter medications in proper dosages. One medically effective agent which is particularly advantageous comprises gum Arabic powder. Gum Arabic is a natural product, occurring as an exudate from the trunks and branches of the Acacia Senegal tree. Gum Arabic power is water soluble. A six ounce dosage is sufficient to support an adult for twenty-four hours. In some cases of disease, it is considered that a solution of Gum Arabic may for a time constitute the exclusive drink and food of the patient. Herbal extracts may be added to the effervescent supplement tablet. Further, joint supplements may be added to the effervescent supplement tablet.

The effervescent supplement tablet may be utilized for people in flavoring their water, delivering vitamins and/or nutrients, or delivering medicaments. Applications of the effervescent supplement tablet can be used in treatment of animals, such as pets, livestock and equine. In application to animals, medicaments, such as worm medication, nutrients, vitamins and supplements can be administered to the animal through their drinking water. Moreover, the effervescent supplement tablet may be appointed to release scents when being dissolved (via the gas bubbles).

Ingredients of the tablet should be easily dissolved in the bottled water. The solid tablet fizzes resultant from a chemical reaction to produce gas bubbles that yield an effervescent solution. Ingredients utilized to form an effervescent solution when the tablet is dropped in water include a mixture of citric acid and sodium bicarbonate, which, when dropped in water undergo chemical reaction to yield carbon dioxide and sodium citrate. The essential chemical reaction is:
citric acid+sodium bicarbonate→water+carbon dioxide+sodium citrate C₆H₈O₇+3NaHCO₃→3H₂O+3CO₂+Na₃C₆H₅O₇

Powdery ingredients may be pulverized to a fine mesh particle size to enable compression into tablet form, while having large enough surface area for quick dissolution when in water/when dropped in the liquid. For example 100 mesh particles have an average diameter of 140 microns while a 325 mesh particles have a diameter of only 44 microns thereby presenting a larger surface area. A 5 micron particle size results in a significantly larger surface area available for dissolution. Liquid or sticky ingredients may be microencapsulated in the effervescent tablets, which are free flowing or readily dissolving.

The tablet is composed of a mixture of supplement ingredients, citric acid and sodium bicarbonate, and flavorings, pressed or compacted into a tablet form. Excipients, or inactive ingredients, may be included, such as water soluble binders; sweeteners or flavors; pigments to make tablets visually attractive; and effervescent enabling ingredients (such as citric acid and sodium bicarbonate). A soluble coating may be applied to provide taste, or to make it more resistant to the environment, extending its shelf life. A wide variety of binders may be used, including starch, cellulose, lactose powder, dibasic calcium phosphate, sucrose, corn (maize) starch, microcrystalline cellulose and modified cellulose (for example hydroxymethyl cellulose), and/or sorbital.

The effervescent tablets are stored in a container or package, or singly wrapped and stored in peel away packages as part of a system adhered onto a vessel holding water, such as a water bottle or water cooler 2-5 gallon bottle. Since moisture permeates easily into peel away packages, they should be made from a packaging material that prevents moisture diffusion or permeation. Packaging materials of this functionality are readily available and are typically polyethylene films with an aluminized coating. The packages may have a notch to readily open the package for delivering the contents to the bottled water.

Wherein the effervescent tablets are provided as part of a refreshment system, the tablets are preferably housed in peel away packages which are preferably attached to the packages by means of a transfer film. The transfer film is typically a tape with adhesive on both sides. One side of the transfer tape adheres to the peel away package while the other side of the tape adheres to the external side wall of the water bottle. The adhesive that attaches the packages to the external surface of the water bottle is week adhesive similar to that utilized for adhesive layered paper tabs as sold under the trademark Post-It™, and does not leave behind a glue coating on the bottle external surface. Since the peel away packages are moisture resistant, washing the bottle does not cake or damage the nutrition and supplement composition contained within the packages. Pigments may be provided to yield a specific color or color combination.

The effervescent supplement tablet may be microencapsulated in a gelatin capsule for enhanced protection against moisture degradation to the effervescent supplement tablet. Such application is useful wherein the tablets are in a container and are not each separately sealed in packages. The gelatin capsules immediately dissolve when the tablet is dropped in water, causing water to penetrate the tablet and chemical reaction to take place, giving off gas bubbles and yielding an effervescent solution. The propensity of gelatin capsules to rapid dissolution in water makes gelatin a preferred encapsulant. Alternatively, the effervescent supplement tablet may be encapsulated with a water soluble coating, such as a sugary coating to aid in protecting the tablet from degradation, while providing sweetener to the water. In another embodiment, the effervescent supplement tablets are each housed in a peel away package that is adhesively attached to an external surface of a water bottle.

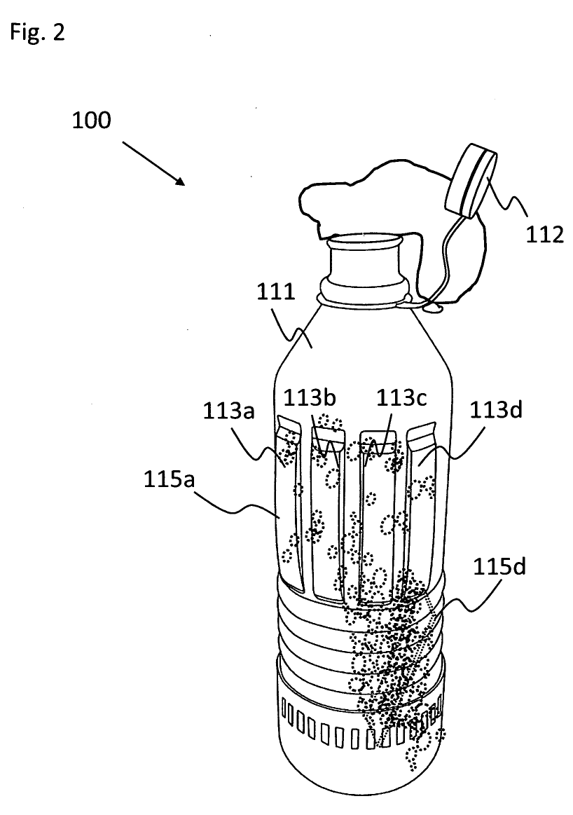

FIG. 2 is a schematic view of the water bottle with peel away packages containing effervescent supplement tablets therein, wherein a package has been peeled away and an effervescent supplement tablet has been added to water within the water bottle, shown generally at 100. Water bottle 111 is provided with a cap 112, shown in the open configuration, and a plurality of peel away packages 113a through 113d contain effervescent supplement tablets 115 therein. For example, 113a may be labeled multivitamin plus, which provides an effervescent supplement tablet 115a having multivitamins therein plus nutrients and/or added ingredients; 113b may be labeled fresh citrus plus; 113c may be labeled electrolyte plus; 113d may be labeled stress relief plus. The cap 112 is first removed. One or more selected peel away packages 113d, for example, may be torn and the effervescent supplement tablet 115d contained therein is delivered into the bottled water. If necessary, the bottle may be recapped and shaken to promote uniform distribution of the added ingredients and promote dissolution.

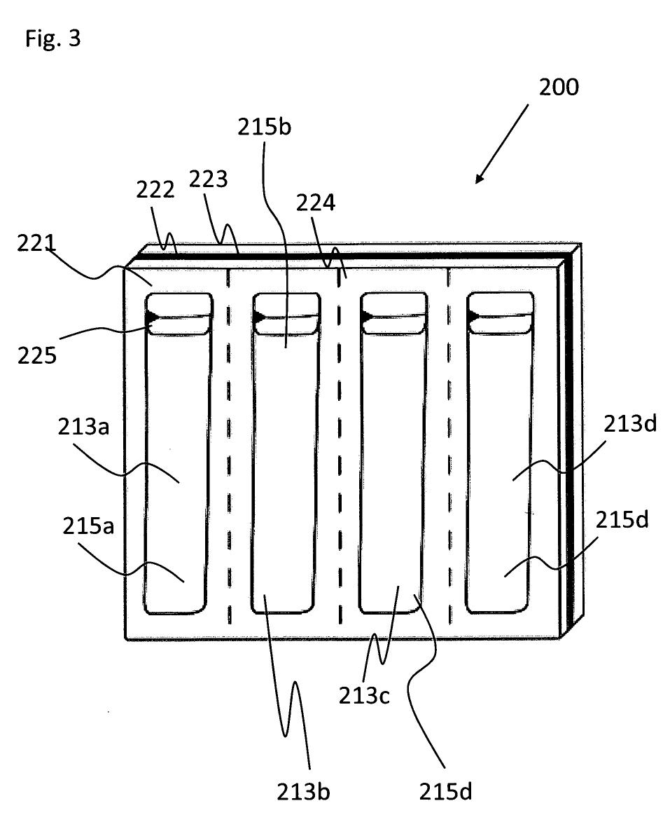

FIG. 3 illustrates a schematic view of the peel away packages each with an effervescent supplement tablet therein, wherein the peel away packages are designed for attachment to a refillable water bottle, or disposable water bottle, shown generally at 200. A typical peel away strip 221 with a plurality of packages 223a through 223d, each containing various ingredient laden effervescent supplement tablets 215a through 215d. The backside of the strip has an adhesive coating 222 and a protective tape 223 covering the adhesive. This protective tape 223 is removed prior to the application of the strip on a washable water bottle, or on a gallon water bottle utilized in conjunction with a water cooler (typically a 2 or 5 gallon water container such as delivered through water supply vendors, for example that sold or performed under the trade name Poland Springs™). The washable water bottle may be insulated. Perforations at 224 permit the removal of any of the strips 213a through 213d. The notch at 225 allows easy tearing of the package after its removal to discharge the contents into the bottled water.

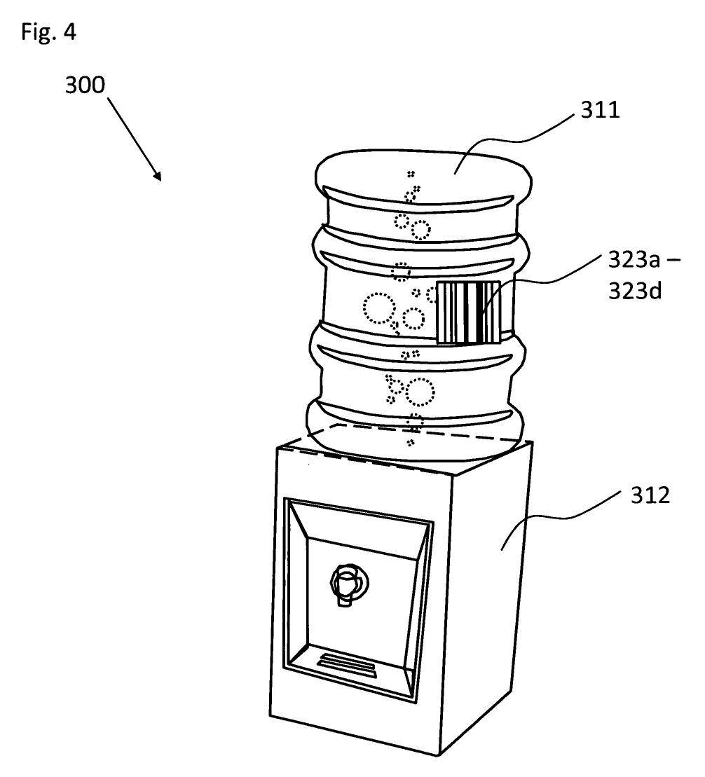

FIG. 4 is a schematic view of the water cooler—gallon bottle with peel away packages containing effervescent supplement tablets therein, as discussed hereinabove pertaining to FIG. 3, shown herein at 300. Peel away packages 323a-323d are designed for attachment to a gallon jug 311 located on a water cooler device 312 so that an effervescent supplement tablet can be readily added to a glass of water dispensed form the water cooler.

The fluid refreshment system providing water bottles with peel away effervescent supplement tablet packages comprises, in combination, the following salient features:
1. a water bottle or vessel having a closure cap and an external sidewall surface;
2. the water bottle being a disposable one time use bottle or a washable refillable water bottle, or a larger gallon bottle as used in conjunction with a water cooler unit;
3. one or more peel away effervescent supplement tablet packages attached with removable adhesive to the external sidewall surface of the water bottle;
4. the packages containing effervescent supplement tablet therein;
5. the effervescent supplement tablets comprising: a supplement ingredient; and effervescent ingredients, citric acid and sodium bicarbonate, so that the effervescent supplement tablet effervescently dissolves in the fluid refreshment to deliver the supplemental ingredient to a person or animal during consumption;
6. the effervescent supplement tablet preferably including nutritional ingredients comprising vitamins and/ or minerals, antioxidants, and electrolytes;
7. the supplement ingredients including flavor and taste enhancers, medically effective agents and effervescent properties (carbon dioxide bubble producing chemical combinations);
8. optionally, the effervescent supplement tablets being packaged in sealed moisture impermeable packets capable of being washed;
9. the moist impermeable film being a polyethylene sheet coated with a continuous aluminum layer;
10. the packages having a notch for easy tearing and for discharging the effervescent supplement tablet into bottled water for effervescent dissolving and release of ingredients into the water for consumption;
whereby the user may select one or more nutritional ingredients or supplement ingredients for addition to bottled water by selecting a specific effervescent supplement tablet, thereby customizing the drink beverage without having to buy, transport and store multiple premixed and commercially sold compositions contained within water bottles.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An effervescent supplement tablet for use in a beverage, comprising:
a. a supplement ingredient; and
b. effervescent ingredients so that said supplement effervescent tablet effervescently dissolves in said beverage to deliver said supplemental ingredient to a person or animal during consumption;
whereby said effervescent supplement tablet is appointed to be dissolved in said beverage, thereby customizing said beverage.

2. An effervescent supplement tablet as recited by claim 1 comprising a nutritional ingredient.

3. An effervescent supplement tablet as recited by claim 2, wherein said nutritional ingredient includes a vitamin composition and a mineral composition.

4. An effervescent supplement tablet as recited by claim 2, wherein said nutritional ingredient is an electrolyte composition.

5. An effervescent supplement tablet as recited by claim 3, wherein said vitamin composition includes vitamin A, vitamin B1, B2, B6, B12, vitamin C, vitamin E and coenzyme (CQ10).

6. An effervescent supplement tablet as recited by claim 3, wherein said mineral composition includes calcium compound, magnesium compound, chromium compound, zinc compound, selenium compound and iron compound.

7. An effervescent supplement tablet as recited by claim 1, wherein said supplement ingredient comprises at least one of a flavor enhancing ingredient and a taste enhancing ingredient.

8. An effervescent supplement tablet as recited by claim 7, wherein said flavor enhancing ingredient includes orange flavor, lemon or lime flavor, guava flavor, mango flavor, dragon fruit flavor, green tea, caffeine and guarana, peach flavor, or strawberry flavor.

9. An effervescent supplement tablet as recited by claim 7, wherein said taste enhancing ingredient includes a sweetener and an acidifier.

10. An effervescent supplement tablet as recited by claim 1, wherein said supplement ingredient comprises at least one medically effective agent

11. An effervescent supplement tablet as recited by claim 10, wherein said medically effective agent includes aspirin and over the counter medications.

12. An effervescent supplement tablet as recited by claim 10, wherein said medically effective agent is Gum Arabic.

13. An effervescent supplement tablet as recited by claim 1 comprising herbal extracts.

14. An effervescent supplement tablet as recited by claim 1 comprising joint supplements.

15. An effervescent supplement tablet as recited by claim 1, wherein said animal is a pet or livestock and said effervescent supplement tablet further comprise a medically effective agent.

16. An effervescent supplement tablet as recited by claim 1, wherein said effervescent ingredients comprises a mixture of citric acid and sodium bicarbonate.

17. An effervescent supplement tablet as recited by claim 1, wherein said effervescent supplement tablet is microencapsulated in gelatin capsule.

18. An effervescent supplement tablet as recited by claim 1, wherein said supplement ingredients comprise flavorings, sweeteners, pigments.

19. An effervescent supplement tablet as recited by claim 1 comprising a soluble coating.

20. An effervescent supplement tablet as recited by claim 1 comprising a peel away package adhesively attached to an external surface of a vessel having water housed therein.

21. A fluid refreshment system, comprising:
a. a liquid containing vessel having a closure cap and an external surface;
b. one or more peel away packages adhesively attached to said external surface of said vessel;
c. said peel away packages containing effervescent supplement tablets therein, said effervescent supplement tablets comprising:
i. a supplement ingredient; and
ii. effervescent ingredients so that said effervescent supplement tablet effervescently dissolves in said fluid refreshment to deliver said supplemental ingredient to a person or animal during consumption;
d. said one or more packages being adapted to be peeled away and torn to deliver said effervescent supplement tablets into said fluid refreshment within said vessel;
whereby said person may select one or more effervescent supplement tablets to add to said fluid refreshment within said vessel, thereby customizing said fluid refreshment without having to buy, transport and store multiple commercially sold vessels containing premixed liquid compositions.

22. A fluid refreshment system as recited by claim 21, wherein said vessel is a disposable polymeric water bottle.

23. A fluid refreshment system as recited by claim 21, wherein said vessel is a washable refillable, polymeric water bottle.

24. A fluid refreshment system as recited by claim 21, wherein said peel away packages comprise a sealed, continuous, aluminum-coated polyethylene film.

25. A fluid refreshment system as recited by claim 21, wherein said peel away packages have a notch therein to facilitate tearing.

26. A fluid refreshment system as recited by claim 21, wherein said adhesive is a transfer film tape.

27. A fluid refreshment system as recited by claim 21, wherein said effervescent supplement tablet comprises a nutritional ingredient.

28. A fluid refreshment system as recited by claim 27, wherein said nutritional ingredient includes a vitamin composition and a mineral composition.

29. A fluid refreshment system as recited by claim 27, wherein said nutritional ingredient is an electrolyte composition.

30. A fluid refreshment system as recited by claim 28, wherein said vitamin composition includes vitamin A, vitamin B1, B2, B6, B12, vitamin C, vitamin E and coenzyme (CQ10).

31. A fluid refreshment system as recited by claim 28, wherein said mineral composition includes calcium compound, magnesium compound, chromium compound, zinc compound selenium compound and iron compound.

32. A fluid refreshment system as recited by claim 21, wherein said supplement ingredient of said effervescent supplement tablet comprises at least one of a flavor enhancing ingredient and a taste enhancing ingredient.

33. A fluid refreshment system as recited by claim 21, wherein said supplement ingredient of said effervescent supplement tablet comprises at least one medically effective agent.

34. A fluid refreshment system as recited by claim 21, wherein said effervescent ingredients of said effervescent supplement tablet comprises a mixture of citric acid and sodium bicarbonate.

35. A fluid refreshment system as recited by claim 21, wherein said vessel is thermally insulated.
